(19) United States
(12) Patent Application Publication
(10) Pub. No.: US 2025/0231307 A1
(43) Pub. Date: Jul. 17, 2025

(54) METHOD AND SYSTEM FOR DETECTING A GEOLOGICAL OBJECT IN A SEISMIC 3D IMAGE BY USING IMAGE SEGMENTATION

(71) Applicant: TotalEnergies OneTech, Courbevoie (FR)

(72) Inventors: Frédérik Pivot, Pau (FR); Lionel Boillot, Pau (FR)

(21) Appl. No.: 18/853,647

(22) PCT Filed: Apr. 6, 2022
(86) PCT No.: PCT/IB2022/000200

§ 371 Date: Oct. 2, 2024

(51) Int. Cl. G01V 1/30; G01V 20/00

(52) U.S. Cl. CPC G01V 1/301; G01V 20/00

(57) ABSTRACT

A computer implemented method provides for detecting a geological object in a geological formation by processing a seismic 3D image, said seismic 3D image comprising a plurality of pixels representing seismic measurements performed on the geological formation. The method includes computing, based on the seismic 3D image, a geological-time (GT) isochronous surface of the geological formation, wherein the GT isochronous surface corresponds to the coordinates of pixels of the seismic 3D image which represent portions of the geological formation considered to have a same geological age, computing a seismic attribute 2D image representing at least one seismic attribute of the geological formation on the GT isochronous surface, and detecting, by image segmentation, pixels of the seismic attribute 2D image which represent the geological object.

### BACKGROUND

### Technical Field

The present disclosure relates to the processing of seismic 3D images of a geological formation and relates more specifically to the automatic detection of geological objects, such as channelized systems, in the geological formation.

### Description of the Related Art

It is known, especially in oil exploration, to determine the position of oil reservoirs from the results of geophysical measurements on a geological formation, carried out from the surface or in well bores. Such geophysical measurements can also be used for, e.g., gas (or more generally hydrocarbon) exploration, geological CO₂ trap exploration, etc.

According to the technology of reflection seismology, such seismic measurements involve emitting a wave (e.g., acoustic waves) into the subsurface and measuring a signal, referred to as seismic trace, comprising a plurality of echoes of the wave on geological structures being investigated. These structures are typically surfaces separating distinct materials, faults, etc.

A seismic 3D image comprises a juxtaposition in a volume of seismic traces. In the seismic 3D image, the value of a pixel (a.k.a. voxel for a 3D image) is proportional to the seismic amplitude represented by seismic traces.

Such seismic 3D images can be used to detect geological objects of interest, in particular channelized systems which are key potential reservoirs.

Currently, detecting these geological objects relies mainly on manual delimitation in vertical slices of the seismic 3D images. Hence, it can be a time expensive work that requires high experience of seismic interpretation. Interpreters can also use seismic attributes for characterizing the turbiditic texture of the systems (energetic and quite chaotic reflections, see for example patent application EP 0923764 A1). However, these methods detect more than the true turbiditic systems and other non-interesting facies are captured.

Hence, there is a need for a solution enabling to automatically detect geological objects in a seismic 3D image.

### BRIEF SUMMARY

The present disclosure aims at improving the situation. In particular, the present disclosure aims at overcoming at least some of the limitations of the prior art discussed above, by proposing a solution for automatically detecting geological objects of interest in a geological formation, such as channelized systems, by using at least a seismic 3D image obtained from seismic measurements carried out on the geological formation.

Also, the present disclosure aims at proposing a solution that enables, in some embodiments, automatically delimiting the 3D volume of a geological object detected in a geological formation.

According to a first aspect, the present disclosure relates to a computer implemented method for detecting a geological object in a geological formation by processing a seismic 3D image, said seismic 3D image comprising a plurality of pixels representing seismic measurements performed on the geological formation, said method comprising:
computing, based on the seismic 3D image, a geological-time (GT) isochronous surface of the geological formation, wherein the GT isochronous surface corresponds to the coordinates of pixels of the seismic 3D image which represent portions of the geological formation considered to have a same geological age,
computing a seismic attribute 2D image representing at least one seismic attribute of the geological formation on the GT isochronous surface, and
detecting, by image segmentation, pixels of the seismic attribute 2D image which represent the geological object.

Hence, the proposed solution, instead of processing 2D vertical slices of the seismic 3D image, proposes to try and detect a geological object in a seismic attribute 2D image representing a seismic attribute of the geological formation on a GT isochronous surface. Hence, the pixels of the seismic attribute 2D image represent the seismic attributes of portions of the geological formation designated by the GT isochronous surface as having the same geological age.

Determining GT isochronous surfaces is also known as chrono-stratigraphic analysis (or sequence stratigraphic analysis). Computing a chrono-stratigraphic representation of a seismic 3D image often requires determining seismic horizon surfaces of the seismic 3D image. Such a seismic horizon surface can be used as an estimated GT isochronous surface of the geological formation for detecting a geological object. For instance, [LOMASK2006] describes a method for determining seismic horizon surfaces based on a seismic 3D image, by computing the local seismic dip at each pixel of the seismic 3D image and searching iteratively for surfaces having local gradients approaching the local seismic dips. Also, such seismic horizon surfaces can be used to determine a relative geological time (RGT) image of the geological formation, i.e., an image in which each pixel provides an estimated geological age for the portion of the geological formation represented by said pixel (see, e.g., [GUILLON2013]). The RGT image is referred to as “relative” because the purpose of the RGT image is mainly to be able to compare the estimated geological ages of different pixels, in order to, e.g., identify portions of the geological formation that have the same estimated geological age. Also, in practice, it is usually not possible to estimate an absolute geological age of any given portion of the geological formation. An RGT surface, i.e., a set of coordinates of pixels of the RGT image which have the same estimated geological age, can also be used as an estimated GT isochronous surface of the geological formation for detecting a geological object.

For instance, channelized systems of a geological formation are composed of turbidites that may split, merge, and cross each other, sometimes in deep and large erosive canyons, sometimes in a more constructive process. Deposits resulting from channelized systems are then distorted by tectonic forces. Hence, the complexity of such channelized systems can be better analyzed in a map view, from above, following the stratigraphic successive deposits in geological time. Hence, working on stratigraphic layers, i.e., on GT isochronous surfaces, is advantageous for detecting geological objects such as channelized systems, since each channel was formed, flowed, and dried during a certain geological time.

The pixels of the seismic attribute 2D image represent a seismic attribute of the geological formation on the GT isochronous surface, i.e., for portions of the geological formation considered to have the same geological age. Hence, such a seismic attribute 2D image is particularly advantageous for detecting a geological object in the geological formation and is then processed by automatic image segmentation to detect a geological object, such as a channelized system.

In specific embodiments, the detecting method can further comprise one or more of the following optional features, considered either alone or in any technically possible combination.

In specific embodiments, the detecting method comprises:
computing a plurality of GT isochronous surfaces of the geological formation based on the seismic 3D image,
computing a plurality of seismic attribute 2D images associated respectively to the GT isochronous surfaces, and
detecting, by image segmentation, pixels representing the geological object in each seismic attribute 2D image.

In specific embodiments, the detecting method comprises generating a 3D representation of the geological object based on the pixels representing the geological object in a plurality of seismic attribute 2D images, by using the coordinates of said pixels in the seismic 3D image.

In specific embodiments, the pixels representing the geological object in a seismic attribute 2D image are detected by using a previously trained machine learning model, preferably a deep learning model.

In specific embodiments, the machine learning model is a deep neural network, preferably a U-Net.

In specific embodiments, the geological object to be detected is a geological sedimentary object stratigraphically deposited. For instance, the geological object is one among:
a channelized system,
a lobe system, or
a debris flow deposit.

In specific embodiments, the at least one seismic attribute represented by a seismic attribute 2D image comprises at least one among the following, or any combination thereof:
a structural seismic attribute,
an energetic seismic attribute, or
a spectral seismic attribute.

In specific embodiments, computing a GT isochronous surface comprises computing, based on the seismic 3D image, a relative geological-time (RGT) 3D image and extracting from the RGT 3D image the coordinates of pixels having the same estimated geological age.

In specific embodiments, computing a seismic attribute 2D image comprises computing a seismic attribute 3D image for the geological formation and extracting from the seismic attribute 3D image the pixels on the GT isochronous surface.

According to a second aspect, the present disclosure relates to a computer program product comprising instructions which, when executed by at least one processor, configure said at least one processor to carry out a detecting method according to any one of the embodiments of the present disclosure.

According to a third aspect, the present disclosure relates to a computer-readable storage medium comprising instructions which, when executed by at least one processor, configure said at least one processor to carry out a detecting method according to any one of the embodiments of the present disclosure.

According to a fourth aspect, the present disclosure relates to a computer system for processing a seismic image, said computer system comprising at least one processor and at least one memory, wherein said at least one processor is configured to carry out a detecting method according to any one of the embodiments of the present disclosure.

### BRIEF DESCRIPTION OF THE SEVERAL VIEWS OF THE DRAWINGS

The disclosure will be better understood upon reading the following description, given as an example that is in no way limiting, and made in reference to the figures which show:

FIG. 1 is an example of seismic image,

FIG. 2 is a flow chart illustrating the main steps of a method for detecting a geological object in a geological formation,

FIG. 3 shows a superposition of a seismic 3D image, an RGT 3D image and a seismic attribute 2D image,

FIG. 4 shows an example of seismic attribute image before and after image segmentation,

FIG. 5 is a flow chart illustrating the main steps of a preferred embodiment of the detecting method.

In these figures, identical references from one figure to another designate identical or analogous elements. For reasons of clarity, the elements shown are not to scale, unless explicitly stated otherwise.

Also, the order of steps represented in these figures is provided only for illustration purposes and is not meant to limit the present disclosure which may be applied with the same steps executed in a different order.

### DETAILED DESCRIPTION

As discussed above, the present disclosure relates to a method 20 for detecting a geological object in a geological formation by using at least one seismic 3D image. For instance, the geological object to be detected is a sedimentary object such as, e.g., a channelized system, a lobe system, a debris flow deposit, etc.

A seismic 3D image represents a picture of the subsoil arising from a seismic exploration survey. The seismic 3D image comprises three dimensions which may comprise two horizontal dimensions (which usually uses a distance scale, expressed, e.g., in meters) and one vertical dimension (which usually uses a distance scale or a time scale, expressed, e.g., in seconds).

It is emphasized that the expressions “horizontal dimension” and “vertical dimension” are not to be interpreted as requiring these dimensions to be respectively strictly horizontal and strictly vertical. These expressions mean that one of the dimensions, referred to as “vertical dimension,” is representative of the depth of the geological formation, and that the other dimensions, referred to as “horizontal dimensions” are both orthogonal to the vertical dimension.

The seismic 3D image is composed of pixels (a.k.a. voxels). The pixels are usually regularly distributed according to a horizontal resolution on each horizontal dimension and a vertical resolution on the vertical dimension. The seismic image comprises, along each horizontal dimension:
a number of columns of pixels which is equal to the quotient of the horizontal extension along this horizontal dimension divided by the horizontal resolution along this horizontal dimension; each column of the seismic image may be referred to as “seismic trace”; and
a number of pixels per column which is equal to the quotient of the vertical extension divided by the vertical resolution.

Each pixel is associated with a seismic value which may be a gray value, for instance between 0 and 255 (or 65535). Each seismic value is representative of the amplitude of the seismic signal measured for the portion of the geological formation represented by the corresponding pixel.

In the sequel, a point corresponds to coordinates in the grid of the seismic 3D image, i.e., comprising a horizontal position along each horizontal dimension and a vertical position along the vertical dimension. A pixel therefore corresponds to a point with a value associated thereto (i.e., a seismic value in the case of a pixel of the seismic 3D image, an estimated geological age in the case of a pixel of an RGT 3D image, etc.).

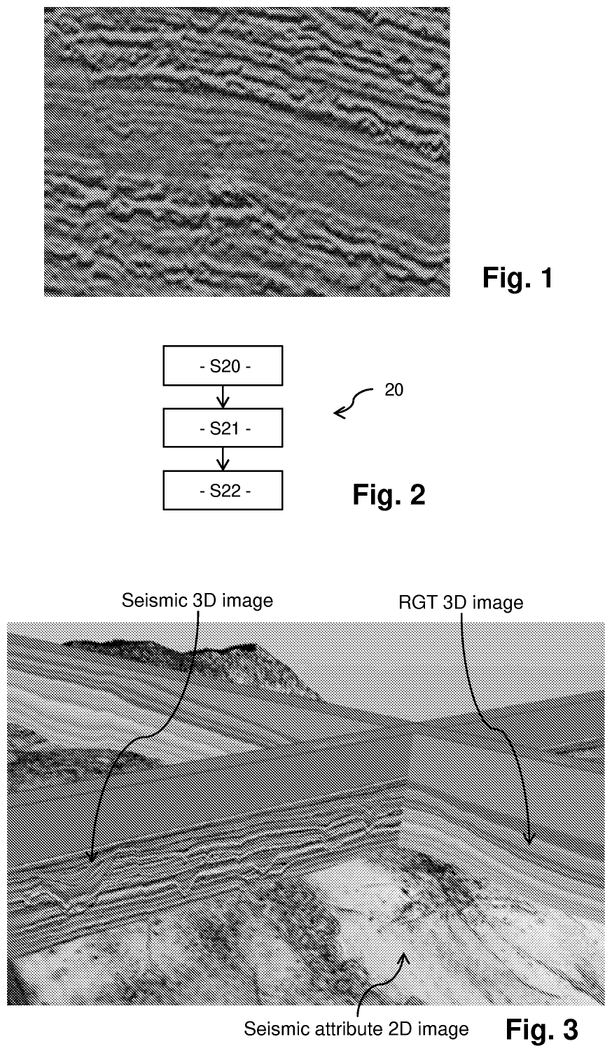

FIG. 1 represents an example of 2D section, in a vertical plane, of a seismic 3D image. As can be seen in FIG. 1, the seismic values highlight the composition of the geological formation, since high amplitude seismic values are usually associated to strong seismic reflectors, which are usually located at the interfaces between geological layers having different acoustic impedances.

FIG. 2 represents schematically the main steps of an exemplary embodiment of a method 20 for detecting a geological object in a geological formation.

The detecting method 20 is carried out by a computer system (not represented in the figures). In preferred embodiments, the computer system comprises one or more processors (which may belong to a same computer or to different computers) and storage means (magnetic hard disk, optical disk, electronic memory, or any computer readable storage medium) in which a computer program product is stored, in the form of a set of program-code instructions to be executed in order to implement all or part of the steps of the detecting method 20. Alternatively, or in combination thereof, the computer system can comprise one or more programmable logic circuits (FPGA, PLD, etc.), and/or one or more specialized integrated circuits (ASIC), etc., adapted for implementing all or part of said steps of the detecting method 20. In other words, the computer system comprises a set of means configured by software (specific computer program product) and/or by hardware (processor, FPGA, PLD, ASIC, etc.) to implement the steps of the detecting method 20.

As illustrated by FIG. 2, the detecting method 20 comprises a step S20 of computing, based on the seismic 3D image, a geological-time (GT) isochronous surface of the geological formation. As discussed above, a GT isochronous surface corresponds to the coordinates of pixels of the seismic 3D image which represent portions of the geological formation considered to have a same geological age. The GT isochronous surface is computed by the computer system, based on the seismic 3D image.

Seismic horizon surfaces, which may be determined by the computer system by using the method described in [LOMASK2006], in the patent applications EP 20306131.2 or FR 2869693, etc., are examples of GT isochronous surfaces that may be used in the detecting method 20.

Also, such seismic horizon surfaces can be used to determine an RGT 3D image of the geological formation. In an RGT 3D image, each pixel provides an estimated geological age for the portion of the geological formation represented by said pixel. An RGT 3D image may therefore be used to obtain RGT surfaces (see below) which are also examples of GT isochronous surfaces.

In general, RGT surfaces are more accurate than seismic horizon surfaces, since an RGT 3D image is computed by using a large number of seismic horizon surfaces, thereby mitigating potential inaccuracies of some seismic horizon surfaces. Hence, using an RGT surface for the GT isochronous surface corresponds to a preferred embodiment of the present disclosure.

In the sequel, we consider in a non-limitative manner that the GT isochronous surface is an RGT surface retrieved from an RGT 3D image of the geological formation, the RGT 3D image being computed based on the seismic 3D image. However, it is emphasized that the step S20 of computing a GT isochronous surface of the geological formation may use any method known to the skilled person for determining GT isochronous surfaces.

We assume that Mₕ seismic horizon surfaces τⁿ (1≤n≤Mₕ) have been determined by using any method known to the skilled person, for instance the method described in [LOMASK2006], in the patent applications EP 20306131.2 and FR 2869693, etc. The seismic horizon surfaces τⁿ are preferably distributed throughout the vertical dimension of the seismic 3D image. Assuming that the seismic image comprises a horizontal dimension x with Nₓ pixels, a horizontal dimension y with N_{y} pixels and a vertical dimension t with Nₜ pixels, then the seismic horizon surface τⁿ of index n corresponds for instance to the set of points of the seismic image {(i, j, τⁿ(i, j), 1≤i≤Nₓ, 1≤j≤N_{y}}.

Then the seismic horizon surfaces τⁿ may be used to compute an RGT 3D image of the geological formation.

For example, the value of each pixel of the RGT 3D image may correspond to the number of seismic horizon surfaces that comprise said considered pixel or that comprise any pixel located in the same column as the considered pixel, between the considered pixel and a reference pixel in the same column. The reference pixel on the vertical axis is the pixel of index k=Nₜ or, preferably, the pixel of index k=1.

For instance, it is possible to compute a stack image STK. The value of each pixel of the stack image STK corresponds to the number of seismic horizon surfaces that comprise said considered pixel. We can define a function Pos(i, j, k, n) which is such that:

$$Pos ( i , j , k , n ) = \{ \begin{matrix}1 if {τ}^{n} ( i , j ) = k \\ 0 if {τ}^{n} ( i , j ) \neq k\end{matrix}$$

Hence, the function Pos(i, j, k, n) indicates whether the seismic horizon surface τⁿ passes by the pixel having the coordinates (i, j, k). Based on the function Pos(i, j, k, n), the stack image STK may be computed as follows:

$$STK ( i , j , k ) = {\sum }_{n = 1}^{{M}_{h}} Pos ( i , j , k , n )$$

for each 1≤i≤Nₓ, 1≤j≤N_{y}, 1≤k≤Nₜ, or limited to the pixels which are located inside a predetermined survey volume in the seismic image.

Then, assuming that the reference pixel is the pixel of index k=1, the RGT 3D image RGT may be computed as follows:

$$RGT ( i , j , k ) = {\sum }_{l = 1}^{k} STK ( i , j , l )$$

for each 1≤i≤Nₓ, 1≤j≤N_{y}, 1≤k≤Nₜ, or limited to the pixels which are located inside the survey volume. For the purpose of chrono-stratigraphic analysis, it is possible, in some embodiments, to normalize the RGT 3D image by a predetermined reference geological age, such that the maximum value of the pixels of the RGT 3D image is equal to the reference geological age.

Then the RGT 3D image may be used to retrieve an RGT surface, i.e., a set of points (set of coordinates) of the RGT image which correspond to pixels having the same estimated geological age. If we denote by S^{iso} an RGT surface retrieved from the RGT 3D image, then it corresponds to the following set of points of the RGT 3D image:

$$\{ ( i , j , {S}^{iso} ( i , j ) ) , 1 \leq i \leq {N}_{x} , 1 \leq j \leq {N}_{y} \}$$

wherein RGT(i, j, S^{iso}(i, j)=K^{iso} for any (i, j) in the set {(i, j), 1≤i≤Nₓ, 1≤j≤N_{y}}, K^{iso} being the estimated geological age of the RGT surface S^{iso}, i.e., the GT isochronous surface determined during step S20.

As illustrated by FIG. 2, the detecting method 20 comprises a step S21 of computing a seismic attribute 2D image representing at least one seismic attribute of the geological formation on the GT isochronous surface. Hence, the pixels of the seismic attribute 2D image represent seismic attributes of portions of the geological formation designated by the GT isochronous surface as having the same geological age.

The seismic attribute may be any type of seismic attribute known to the skilled person, or a combination thereof. For instance, the seismic attribute may be a structural seismic attribute characterizing lateral variations of the seismic traces, such as the seismic coherency. According to another example, the seismic attribute may be an energetic seismic attribute characterizing the contrast of reflectivities between geological layers, such as the amplitude or the envelope of the seismic traces. According to another example, the seismic attribute may be a spectral seismic attribute representing the frequency-domain energy of the seismic traces, related to one or more predetermined spectral bandwidths. The seismic attribute represented by the seismic attribute 2D image may also be a combination of such seismic attributes. For instance, the chaos attribute is a hybrid seismic attribute combining structure (structural seismic attribute) and energy (energetic seismic attribute). The choice of a specific type of seismic attribute therefore corresponds to a specific non-limitative embodiment of the present disclosure. In general, the choice of the seismic attribute will depend on the type of geological object to be detected, and it is considered known to the skilled person that some seismic attributes can be better than others to characterize a given specific type of geological object. For instance, the seismic coherency is an example of seismic attribute that can be used to detect a channelized system.

For instance, in some embodiments, it is possible to compute a seismic attribute 3D image of the geological formation. This seismic attribute 3D image can be computed by using any method known to the skilled person for computing the considered seismic attribute (e.g., seismic coherency). For instance, the seismic attribute 3D image may be computed by using the same seismic 3D image used to compute the GT isochronous surface (and the RGT image in the non-limitative example above). However, in other embodiments, the seismic attribute 3D image may be computed by one or more 3D images representing other geophysical measurements carried out on the geological formation. It is also possible, in other embodiments, to compute the seismic attribute 3D image by using the same seismic 3D image used to compute the GT isochronous surface and one or more other 3D images representing other geophysical measurements carried out on the geological formation.

Such a seismic attribute 3D image is designated by SA^{3D} in the sequel. We assume in a non limitative manner that the pixels of the seismic attribute 3D image SA^{3D} are mapped to the pixels of the seismic 3D image, such that the seismic attribute 3D image SA^{3D} comprises Nₓ×N_{y}×Nₜ pixels. In such a case, the seismic attribute 2D image associated to the GT isochronous surface S^{iso}, designated by SA^{2D}, may correspond to the following set of pixels:

$$\{ {SA}^{2 D} ( i , j ) = {SA}^{3 D} ( i , j , {S}^{iso} ( i , j ) ) , 1 \leq i \leq {N}_{x} , 1 \leq j \leq {N}_{y} \}$$

It should be noted that other methods may be used to compute the seismic attribute 2D image, as long as the pixels of the seismic attribute 2D image represent the seismic attributes of the portions of the geological formation associated to the following set of points, given by the GT isochronous surface:

$$\{ ( i , j , {S}^{iso} ( i , j ) ) , 1 \leq i \leq {N}_{x} , 1 \leq j \leq {N}_{y} \}$$

As discussed above, the seismic attribute 2D image may be computed by using the same seismic 3D image used to compute the GT isochronous surface and/or one or more other 3D images representing other geophysical measurements carried out on the geological formation

As illustrated by FIG. 2, the detecting method 20 comprises a step S22 of detecting, automatically by image segmentation, pixels of the seismic attribute 2D image which represent the geological object.

Indeed, as discussed above the complexity of geological objects, such a channelized systems, can be better analyzed in a map view, from above, following the stratigraphic successive deposits in geological time. Hence, working on stratigraphic layers, i.e., on GT isochronous surfaces, is advantageous for detecting geological objects, and enables achieving a better detection performance than when considering 2D vertical slices. Also it is emphasized that the seismic attribute 2D image represents a seismic attribute on the GT isochronous surface which is typically not a horizontal surface in the seismic 3D image. Indeed, a horizontal surface in the seismic 3D image (a.k.a. time slice surface) corresponds to a surface having the same acquisition time, while we consider instead a GT isochronous surface in the seismic 3D image which is a surface having a same geological time, which in most cases will be neither horizontal nor plane in the seismic 3D image. Working on GT isochronous surfaces instead of horizontal surfaces is advantageous since the analysis is then carried out by following the stratigraphic successive deposits in geological time which have resulted in the geological object. Accordingly, working on GT isochronous surfaces enables achieving a better detection performance than when working on horizontal surfaces of the seismic 3D image.

The detection step S22 may use any segmentation method known to the skilled person, and the choice of a specific segmentation method corresponds to a specific embodiment of the present disclosure.

In preferred embodiments, the pixels representing the geological object in a seismic attribute 2D image are detected by using a previously trained machine learning model, preferably a deep learning model.

For instance, the detection step S22 may use a fully convolutional neural network previously trained for detecting pixels which represent the geological object. Fully convolutional neural networks are neural networks known to the skilled person used inter alia for image segmentation.

In preferred embodiments, the fully convolutional neural network is a U-Net (see, e.g., [RONNEBERGER2015]). Such a U-Net typically comprises two main stages, a.k.a. encoder and decoder, wherein:
the encoder (a.k.a. “contracting path”) successively downsamples the input image, and
the decoder (also known as “contracting path”) successively upsamples back to the original spatial resolution the image received from the encoder.

Indeed, experiments conducted by the inventors have shown that such a U-Net provides good segmentation results for detecting geological objects in seismic attribute 2D images, in particular for detecting channelized systems based on seismic attribute 2D images representing the seismic coherency on GT isochronous surfaces.

Of course, in general, a machine learning model such as a U-Net will be trained for detecting a specific geological object (e.g., a channelized system) based on seismic attribute 2D images representing a specific seismic attribute (e.g., seismic coherency). The detection of different specific types of geological objects will in general use different previously trained machine learning models.

The training of such a machine learning model, for instance a U-Net, may use annotated training images, i.e., training images in which each pixel is already labelled as representing the considered geological object (e.g., channelized system) or not representing the considered geological object. These labels are considered to correspond to the “ground truth,” i.e., the expected result of the segmentation of the training image. Such annotated training images are then used to iteratively optimize parameters of the machine learning model to obtain a parameterized machine learning model yielding substantially the same results as the expected results, for all training images.

FIG. 3 represents schematically, superposed for illustration purposes only, a seismic 3D image, an RGT 3D image and a seismic attribute 2D image. More specifically:
the left part of FIG. 3 shows a vertical slice of the seismic 3D image,
the right part of FIG. 3 shows a vertical slice of the RGT 3D image, in which different layers correspond to different GT isochronous surfaces, and
the lower part of FIG. 3 shows a seismic attribute (the seismic coherency in the example of FIG. 3) of the geological formation on a GT isochronous surface, i.e., a seismic attribute 2D image.

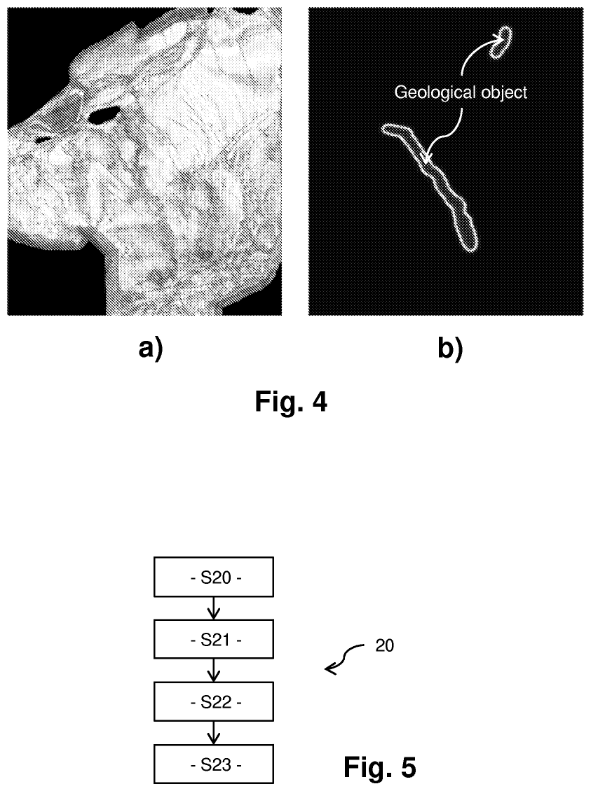

Part a) of FIG. 4 represents schematically an example of seismic attribute 2D image, representing in a non-limitative manner the seismic coherency on a GT isochronous surface. Part b) of FIG. 4 represents schematically the result of the segmentation of the seismic attribute 2D image represented in part a) of FIG. 4, obtained by using a machine learning model (U-Net in this example) previously trained to detect channelized systems.

In preferred embodiments, a plurality of GT isochronous surfaces of the geological formation are computed (step S20) based on the seismic 3D image. For instance, when an RGT 3D image is computed, each different value in the RGT 3D image corresponds to a different geological age, such that it is possible to directly obtain one GT isochronous surface per different estimated geological age in the RGT 3D image. Hence, it is possible to obtain hundreds, or more, of GT isochronous surfaces distributed throughout the vertical dimension of the seismic 3D image.

Then for each GT isochronous surface, it is possible to compute (step S21) one seismic attribute 2D image, and each computed seismic attribute 2D image can then undergo image segmentation to detect (step S22) in each computed seismic attribute 2D image the pixels representing the considered type of geological object to be detected.

FIG. 5 represents schematically the main steps of a preferred embodiment of the detecting method 20. As illustrated by FIG. 5, the detecting method 20 comprises the same steps as the detecting method 20 represented in FIG. 2. During step S20, a plurality of GT isochronous surfaces are computed, as discussed above. During step S21, a plurality of seismic attribute 2D images (representing, e.g., the seismic coherency) are computed, associated respectively to the different GT isochronous surfaces. During step S22, pixels representing the considered type of geological object are detected in each seismic attribute 2D image, by using image segmentation.

As illustrated by FIG. 5, the detecting method 20 comprises a step S23 of generating a 3D representation of the geological object based on the pixels representing the geological object detected in the plurality of seismic attribute 2D images.

Indeed, pixels considered to represent the considered type of geological object are detected on a plurality of GT isochronous surfaces distributed throughout the vertical dimension. Hence, these pixels can be seen as the result of a scanning of the geological object along the vertical dimension, on the successive (non-plane) GT isochronous surfaces. Since the coordinates of these pixels are known in the seismic 3D image, all these pixels can be seen as the result of a 3D sampling of the geological object in the 3D volume of the geological formation. Hence the coordinates of these pixels in the 3D volume of the geological formation can be used to generate a 3D representation of the detected geological object. For instance, such a generation may use conventional 3D reconstruction methods such as interpolation methods. However, any 3D reconstruction method, based on a set of coordinates, may be used and the choice of a specific 3D reconstruction method corresponds to a specific non-limitative embodiment of the present disclosure.

It is emphasized that the present disclosure is not limited to the above exemplary embodiments. Variants of the above exemplary embodiments are also within the scope of the present disclosure.

For instance, the present disclosure has mainly assumed the use of the seismic coherency to detect channelized systems. However, it is also possible to consider other types of seismic attributes and/or other types of geological objects, keeping in mind that some seismic attributes can be better than others to characterize a given specific type of geological object. For instance, the chaos attribute can be used to characterize energetic chaotic seismic signatures like erosive channelized systems filled by smaller channels, or debris flow deposits.

### REFERENCES

[LOMASK2006] Lomask, et al.: “Flattening without picking,” Geophysics, Volume 71 Issue 4 (July-August 2006), pages 13-20.
[GUILLON2013] Sebastien Guillon, Noomane Keskes, Jonathan Gallon, Marc Donias: “Geotime: A 3D automatic tool for chronostratigraphic seismic interpretation and filtering,” Leading Edge, Society of Exploration Geophysicists, 2013, Volume 32, Issue 2, pages 154-159
[RONNEBERGER2015] Olaf Ronneberger, Philipp Fischer and Thomas Brox, “U-Net: Convolutional Networks for Biomedical Image Segmentation,” International Conference on Medical image computing and computer-assisted intervention, Springer, Cham, 2015. pp. 234-241, arXiv: 1505.04597

The various embodiments described above can be combined to provide further embodiments. All of the patents, patent application publications, and non-patent publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer implemented method for detecting a geological object in a geological formation by processing a seismic 3D image, said seismic 3D image comprising a plurality of pixels representing seismic measurements performed on the geological formation, said method comprising:
computing, based on the seismic 3D image, a geological-time (GT) isochronous surface of the geological formation, wherein the GT isochronous surface corresponds to coordinates of pixels of the seismic 3D image which represent portions of the geological formation considered to have a same geological age,
computing a seismic attribute 2D image representing at least one seismic attribute of the geological formation on the GT isochronous surface, and
detecting, by image segmentation, pixels of the seismic attribute 2D image which represent the geological object.

2. The method according to claim 1, comprising:
computing a plurality of GT isochronous surfaces of the geological formation based on the seismic 3D image,
computing a plurality of seismic attribute 2D images associated respectively to the GT isochronous surfaces, and
detecting, by image segmentation, pixels representing the geological object in each seismic attribute 2D image.

3. The method according to claim 2, comprising generating a 3D representation of the geological object based on the pixels representing the geological object in the plurality of seismic attribute 2D images, by using the coordinates of said pixels in the seismic 3D image.

4. The method according to claim 1, wherein the pixels representing the geological object in the seismic attribute 2D image are detected by using a previously trained machine learning model.

5. The method according to claim 4, wherein the machine learning model is a deep neural network.

6. The method according to claim 1, wherein the geological object is a geological sedimentary object stratigraphically deposited.

7. The method according to claim 1, wherein the geological object is one among:
a channelized system,
a lobe system, or
a debris flow deposit.

8. The method according to claim 1, wherein the at least one seismic attribute is one among:
a structural seismic attribute,
an energetic seismic attribute, or
a spectral seismic attribute.

9. The method according to claim 1, wherein computing a GT isochronous surface comprises computing, based on the seismic 3D image, a relative geological-time 3D image and extracting from the RGT 3D image the coordinates of pixels having the same estimated geological age.

10. The method according to claim 1, wherein computing the seismic attribute 2D image comprises computing a seismic attribute 3D image for the geological formation and extracting from the seismic attribute 3D image the pixels on the GT isochronous surface.

11. A computer program product comprising instructions which, when executed by at least one processor, configure said at least one processor to carry out a detecting method according to claim 1.

12. A non-transitory computer-readable storage medium comprising instructions which, when executed by at least one processor, configure said at least one processor to carry out a detecting method according to claim 1.

13. A computer system for processing a seismic 3D image, said computer system comprising at least one processor and at least one memory, wherein the at least one processor is configured to carry out a detecting method according to claim 1.

14. The method according to claim 5, wherein the deep neural network is a U-Net.
